(19) United States
(12) Patent Application Publication
(10) Pub. No.: US 2017/0172074 A1
(43) Pub. Date: Jun. 22, 2017

(54) WOVEN GROUND COVER MATERIALS

(71) Applicant: Nine IP Limited, Auckland (NZ)

(72) Inventor: Jonathan Dallas TOYE, Auckland (NZ)

(21) Appl. No.: 15/115,842

(22) PCT Filed: Feb. 3, 2015
(86) PCT No.: PCT/NZ2015/050006

§ 371 Date: Aug. 1, 2016

(30) Foreign Application Priority Data
Feb. 3, 2014 (NZ) 620668
May 30, 2014 (NZ) 625751

(51) Int. Cl. A01G 13/02; D02J 1/08

(52) U.S. Cl. CPC A01G 13/0268; D02J 1/08

(57) ABSTRACT

A ground cover sheet material for use in agriculture is woven from warp and weft tapes of a plastics material and at least one warp tape comprising a wicking material to form a longitudinal wick in the sheet material through which water or vapour may flow or flow more freely than through the plastics material.

### FIELD OF THE INVENTION

The invention relates to woven ground cover materials.

### BACKGROUND TO THE INVENTION

Ground cover materials are used in agriculture for a number of purposes including weed suppression and/or soil warmth retention and/or moisture retention and/or for light reflecting.

Typically where a material is used for weed suppression (herein referred to as weed matting) in an orchard or vineyard for example, the material is rolled out in lengths onto the ground beneath or between rows of trees or vines, or rows of berry fruit plants, and is secured in place. It is important that the material while suppressing weed growth beneath the material also allows rain or irrigation water penetration through the material.

Typically where a material is used primarily as a reflective ground cover for light enhancement, the material is again rolled out in lengths onto the ground, and secured in place, beneath or between rows of trees, vines, or plants, to increase the amount of light to which the plants and in particular fruit are exposed by reflection of light from the material towards the fruit above.

In either case the material may also aid soil warmth retention.

The sheet material will typically remain in place for some months, before being removed and reused in a subsequent growing season or on another crop in the same growing season, but in some cases may remain In place over multiple growing seasons.

It is an object of the present invention to provide improved ground cover materials, or to at least provide the public with a useful choice.

### SUMMARY OF THE INVENTION

In a first aspect, the invention consists in a ground cover sheet material having a greater length than width and woven from warp and weft tapes of a plastics material and at least one warp tape or weft tape comprising a wicking material to form a longitudinal or lateral wick in the sheet material through which water or water vapour may flow or flow more freely than through the woven plastic warp and weft tapes.

The wick or wicking material provides for more water or water vapour attraction or transmission than the woven plastic warp and weft tapes.

In some embodiments the ground cover sheet material comprises a plurality of said warp tapes or weft tapes each comprising a wicking material to form a plurality of said wicks.

In some embodiments the plurality of wicks are spaced apart across the width of the sheet material or along the length of the sheet material.

In some embodiments the plurality of wicks are grouped together to form a high flow-through area in the sheet material compared to other areas of the sheet material.

In some embodiments the plurality of wicks are grouped together into a plurality of groups spaced apart across the width of the sheet material or along the length of the sheet material to form spaced apart high flow-through areas in the sheet material.

In some embodiments the wicks or groups of wicks are spaced apart evenly across the width of the sheet material.

In some embodiments the wicks or groups of wicks are spaced apart unevenly across the width of the sheet material such that some lengthwise extending regions of the material have a higher density of wicks than other lengthwise extending regions of the material.

In some embodiments the wicks or groups of wicks are spaced apart unevenly across the length of the sheet material such that some widthwise extending regions of the material have a higher density of wicks than other widthwise extending regions of the material.

In some embodiments the thickness of the wicks or the groups of wicks varies across the width and/or length of the material.

In some embodiments the water, or water vapour, transmission rate of the wicks or the groups of wicks varies across the width and/or length of the material.

In some embodiments the wicking material comprises a yarn comprising fibres or filaments interlocked or bundled together.

In some embodiments the yarn is a single strand yarn comprising fibres or filaments interlocked or bundled together.

In some embodiments the fibres or filaments are twisted together, air twisted together, or air entangled together.

In some embodiments the yarn comprises a plurality of strands each comprising fibres or filaments interlocked or bundled together.

In some embodiments the yarn comprises a plurality of strands, each strand comprising fibres or filaments interlocked or bundled together by air entanglement.

In some embodiments the yarn comprises three strands, each strand comprising fibres or filaments interlocked or bundled together by air entanglement.

In some embodiments the wicking material is comprised of one or more polymers selected from the group consisting of polypropylene, polyethylene, polyester, nylon or polyurethane, polyvinyl compounds, polytetrafluorethylene, polycarbonate or polystyrene.

In some embodiments the wicking material is comprised of a single type of polymer.

In some embodiments the wicking material varies in thickness along its length.

In some embodiments the strands are twisted together, air twisted together or air entangled together.

In some embodiments the strands are twisted together at about 40 to 300 twists per meter.

In some embodiments the yarn is aligned side-by-side with another yarn, the yarns running parallel to each other, at least substantially abutting each other along their length with little or no twisting or entanglement.

In some embodiments the strands are twisted together at about 50 to 150 twists per meter, or about 60 to 140 twists per meter, or about 70 to 130 twists per meter, or about 80 to 120 twists per meter, or about 90 to 110 twists per meter, or 110 twists per meter.

In some embodiments the strands are cable twisted together.

In some embodiments the wicking material comprises a yarn, said yarn comprising at least one strand that has fibres or filaments that have been air entangled together.

In some embodiments the at least one strand that has fibres or filaments that have been air entangled together includes fibres or filaments of polyester in combination with fibres or filaments selected from the group consisting of polypropylene, polyethylene or nylon.

In some embodiments the fibres or filaments are air entangled together, the yarn comprising portions of entangled filaments spaced apart along the yarn.

In some embodiments the strands are air entangled together, the fibres or filaments of the strands being air entangled together at portions of entangled filaments spaced apart along the yarn.

In some embodiments the portions of entangled filaments are spaced apart at intervals of between 5 mm and 70 mm, or 5 mm and 60 mm, or 5 mm and 50 mm, or 10 mm and 40 mm, or 15 mm and 30 mm, or 20 mm and 25 mm.

In some embodiments the portions of entangled filaments each have a length of between 1 mm and 50 mm, or 1 mm and 40 mm, or 1 mm and 30 mm, or 1 mm and 20 mm, or 1 mm and 10 mm, or 2 mm and 7 mm, or 3 mm and 6 mm.

In some embodiments the fibres or filaments are twisted together.

In some embodiments the fibres or filaments are air twisted together.

In some embodiments the fibres or filaments are textured.

In some embodiments the strands are combined together by twisting, and the fibres or filaments of at least one of said strands are air entangled together.

In some embodiments the strands are combined together by twisting and the fibres or filaments of at least one of said strands are air twisted together.

In some embodiments the fibres or filaments are formed from one or more of polypropylene, polyethylene, nylon and polyester. In other embodiments the fibres or filaments are formed from one or more of polyurethane, polyvinyl compounds, polytetrafluorethylene, polycarbonate or polystyrene.

In some embodiments the strand comprises fibres or filaments of a first material and fibres or filaments of a second material.

In some embodiments one or more said strands comprises fibres or filaments of a first material and fibres or filaments of a second material.

In some embodiments the yarn comprises a strand comprising fibres or filaments of a first material and a strand comprising fibres or filaments of a second material.

In some embodiments a strand comprising fibres or filaments of the first material is twisted together with a strand comprising fibres or filaments of the second material to form an Intermediate yarn, and the yarn comprises the intermediate yarn air twisted together with at least one strand comprising fibres or filaments of the first material and/or a strand comprising fibres or filaments of the second material.

In some embodiments the at least one strand is formed by any one of twisting, air twisting, or air entanglement methods, and at least one further strand is formed by any one of twisting, air twisting, or air entanglement methods, said strands being formed into a yarn by any one of twisting, cable twisting, air twisting, or air entanglement methods.

In some embodiments the yarn comprises at least two strands comprising fibres or filaments of the first material and a single strand comprising fibres or filaments of the second material.

In some embodiments the yarn comprises two strands comprising fibres or filaments of the first material, the two strands having the same or similar mass, and the strand comprising fibres or filaments of the second material has a different mass.

In some embodiments the yarn comprises two strands comprising fibres or filaments of the first material each having a mass of about 1800 denier, and the strand comprising fibres or filaments of the second material has a mass of about 600 denier.

In some embodiments the yarn comprises a strand comprising fibres or filaments of the first material having a mass of about 1800 denier, and a strand comprising fibres or filaments of the second material having a mass of about 1200 denier.

In some embodiments the yarn comprises two air entangled strands, each comprising fibres or filaments of a first material, and an air entangled strand comprising fibres or filaments of the second material.

In some embodiments the first material is a bulking material and the second material is a hydrophilic material

In some embodiments the first material is polypropylene and the second material is polyester.

In some embodiments wherein the two strands comprising fibres or filaments of a first material each have a denier of about 1200 denier and the strand comprising fibres or filaments of the second material has a denier of about 600 denier.

In some embodiments the strands are formed into a yarn by twisting.

In some embodiments the strands are formed into a yarn by air twisting.

In some embodiments the first material is polypropylene and the second material is polyester, said materials formed into a yarn by air entanglement.

In some embodiments the first material is more hydrophobic than the second material, the second material being more hydrophilic than the first material.

In some embodiments the first material is polypropylene and the second material is polyester or nylon.

In some embodiments the first material is polypropylene and the second material is polyethylene.

In some embodiments the first material is polyester and the second material is polyethylene.

In some embodiments the yarn comprises a strand comprising fibres or filaments of the first material, a strand comprising fibres or filaments of the second material, and a strand comprising fibres or filaments of a third material.

In some embodiments the yarn comprises a plurality of strands comprising fibres or filaments of the first material, a single strand comprising fibres or filaments of the second material, and a single strand comprising fibres or filaments of a third material.

In some embodiments the third material is one of polypropylene, polyethylene, nylon, polyester, polyurethane, polyvinyl compounds, polytetrafluorethylene, polycarbonate or polystyrene.

In some embodiments the mass of each strand is about 500 to 3000 denier.

In some embodiments the mass of the yarn is about 2000 to 5500 denier, or about 1000 to 2000 denier, or about 500 to 1000 denier.

In some embodiments the yarn comprises about 50 to 2500, or about 100 to 2000, or about 150 to 1800 fibres or filaments per cross section of the yarn.

In some embodiments the wicking material comprises a braided material. In some embodiments the wicking material is a braided material. In some embodiments the wicking material is a non-woven material. In some embodiments the wicking material is a felt material. In some embodiments the wicking material is a woven material. In some embodiments the wicking material is a yarn.

In some embodiments the wicks are spaced apart by 20 mm to 1 m, or 30 mm to 500 mm, or 30 mm to 300 mm, or 30 mm to 150 mm, or 30 mm to 50 mm.

In some embodiments the high flow-through area is 2 mm to 200 mm wide, or 10 mm to 150 mm wide.

In some embodiments the high flow-through areas are spaced apart by 30 mm to 1 m, or 100 mm to 500 mm, or 100 mm to 300 mm.

In some embodiments the sheet material may have a porosity of less than 10%, less than 5%, less than 3%, or less than 1%. The term “porosity” as used in this specification is intended to mean the area of the holes or apertures directly through the woven material between the warp and weft tapes of the material relative to the whole surface area of the material, expressed as a percentage, and when viewed from an angle perpendicular to the plane of the material. For example, a material having warp and weft tapes spaced apart from each other so that the air space between the warp and weft tapes constitutes 10% per square meter surface area of the material will have a porosity of 10%. The porosity is made up of small evenly spaced apertures rather than large holes.

The sheet material of the invention may be formed with the plastic warp and weft tapes woven together in a tight weave so as to have high weed suppression characteristics (by low light transmission) while still allowing water penetration through the wicking material.

The term “tape” or “tapes” Is intended to include longitudinally extending single filament elements having four sides when viewed in cross-section, such as a rectangular or square cross-section, also longitudinally extending elements having a multisided cross-section such as a triangular or hexagonal cross-section for example, and also longitudinally extending elements having a circular or oval or similar cross-section. With reference to a woven sheet material the term “tape” is intended to mean a longitudinal element woven into the sheet material, for example a warp element extending longitudinally in the sheet material or a weft element extending across the sheet material. For example a yarn (defined below) woven longitudinally in a sheet material may be described as a warp tape. The term also includes two or more parallel yarns arranged to run side-by-side, either twisted or not twisted, and abutting each other along their length.

Plastic tapes may be formed from any suitable polyolefin such as polyethylene or polypropylene, for example, or a mixture thereof, or an ethylene alpha-olefin, or a polyester, or a biopolymer, or a blend of any of the foregoing. Certain plastics, such as of polyurethane, polyvinyl compounds, polytetrafluorethylene, polycarbonate or polystyrene, are particularly useful when present as minor or major components. Ethylene vinyl acetate (EVA), ethylene butyl acrylate (EBA) and ethylene methyl acrylate (EMA) are useful for imparting elasticity and other properties. Polyesters and polystyrene, styrene-butadiene (SB), acrylonitrile-butadiene-styrene (ABS), styrene-acrylonitrile (SAN), polyethylene terephthalate (PET), polymethylmethacrylate (PMMA) and polycarbonate are useful as dye carriers. Starch and other plant polymers are useful to increase biodegradability. Alternatively the tapes may comprise in part or whole of paper, wood or cellulose fibre, starch based polymers, casein, latex or in any combination of the above and/or with petroleum derived plastic polymers. The polymer or polymer blend may incorporate agents such as one or more pigments, UV stabilisers, or processing aids.

Typically sheet materials of the invention will be laid out in lengths on the ground between or beneath rows of the crop being grown, which may be trees, vines, bushes etc, and the materials are referred to in the specification as “ground cover sheet materials”. It is possible however that the materials may be suspended or positioned above the ground in a vertical or angled position to reflect the solar radiation onto the crop, for example on either side of the crop row, for example trees, and the expression “ground cover sheet material” is intended to encompass materials for such applications also.

The term “twisting” as used herein refers to the twisting of fibres or filaments into a strand or yarn, or the twisting of strands into a yarn. For multi-strand yarns it includes cable twisting, where the fibres or filaments forming the strands (or plies) are twisted in the opposite direction to strands (or plies) forming the yarns. It also includes yarns where the strands (or plies) and filaments are twisted in the same direction. The term is distinct from air twisting, or air entangling, unless the context otherwise requires.

The term “yarn” is intended to mean a long continuous length of fibres or filaments bundled or interlocked together or a single filament. Typically a yarn will have about 100 or more fibres or filaments per cross section of the yarn. A yarn may comprise a single strand comprising fibres or filaments bundled or interlocked together, or a yarn may comprise multiple strands twisted or bundled together, each strand comprising fibres or filaments bundled or interlocked together. For example, a yarn may comprise two or more strands twisted together, each strand comprising a long continuous length of fibres or filaments bundled or interlocked together, for example by twisting.

In preferred embodiments a “wick” or a “wicking material” is a material that conveys liquid by capillary action.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

As used herein the term “and/or” means “and” or “or”, or both.

As used herein “(s)” following a noun means the plural and/or singular forms of the noun.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

The invention consists in the foregoing and also envisages constructions of which the following gives examples only.

### BRIEF DESCRIPTION OF THE DRAWINGS

Preferred embodiments of the invention will be further described by way of example only and with reference to the accompanying drawings, in which:

FIG. 1 is a schematic stylised plan view of a section of ground cover material woven with warp and weft tapes;

FIG. 2 is a perspective view of a woven ground cover material fixed between two rows of trees;

FIG. 3A is an elevation view of woven ground cover materials fixed to the ground between rows of trees or crops growing on mounded soil;

FIG. 3B is an elevation view of woven ground cover materials fixed to the ground between rows of trees or crops growing on flat soil;

FIG. 3C is an elevation view of woven ground cover materials fixed to the ground between rows of trees or crops growing on sloping soil;

FIGS. 4A and 4B are schematic perspective views showing the typical defining dimensions of rectangular and circular cross-section warp or weft tapes used to weave the ground cover materials of the invention;

FIG. 5 is a close up cross-section schematic representation of a section of one embodiment of a ground cover material of the invention which comprises a wicking material warp tape;

FIG. 6 is a close up cross-section schematic representation of a section of another embodiment of a ground cover material of the invention which comprises a wicking material warp tape.

FIG. 7 shows an air twisted yarn for use as a wicking material in a ground sheet material according to some embodiments of the present invention.

FIG. 8 shows an air entangled yarn for use as a wicking material in a ground sheet material according to some embodiments of the present invention.

FIG. 9 is a schematic representation of a section of one embodiment of a ground cover material of the Invention which comprises a wicking material warp tape made up of two yarns running parallel to each other, the parallel yarns not being twisted together or with each other.

### DETAILED DESCRIPTION OF PREFERRED EMBODIMENTS

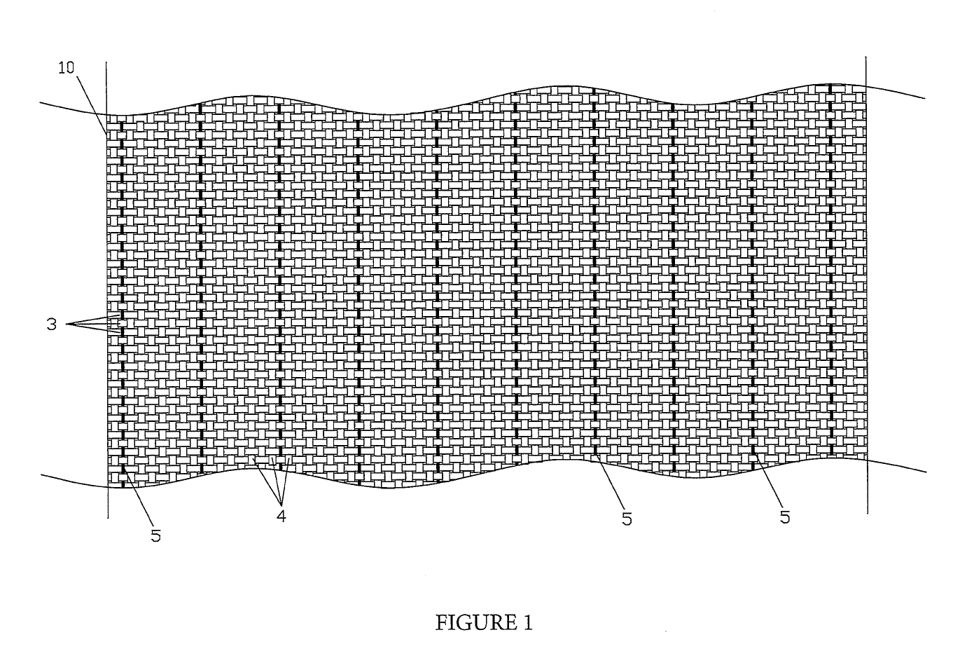

FIG. 1 shows a section of ground cover material or sheeting 10. The material 10 is woven from warp 4 and weft 3 tapes of a plastics material. The tapes may be formed by extruding a film material from a polymer resin and then cutting the film into tapes which are in turn used to weave the material, or by extruding individual tapes. In some embodiments the material has minimal porosity and few if any apertures through the sheet material are apparent. The material is thus therefore effective as a weed suppressant. In the sheet material of FIG. 1 apertures between tapes are visible, however, in a preferred embodiment the plastic warp and weft tapes are woven together in a tight weave so that apertures between tapes are not apparent. The material may be generally impermeable to water, or of low permeability to water.

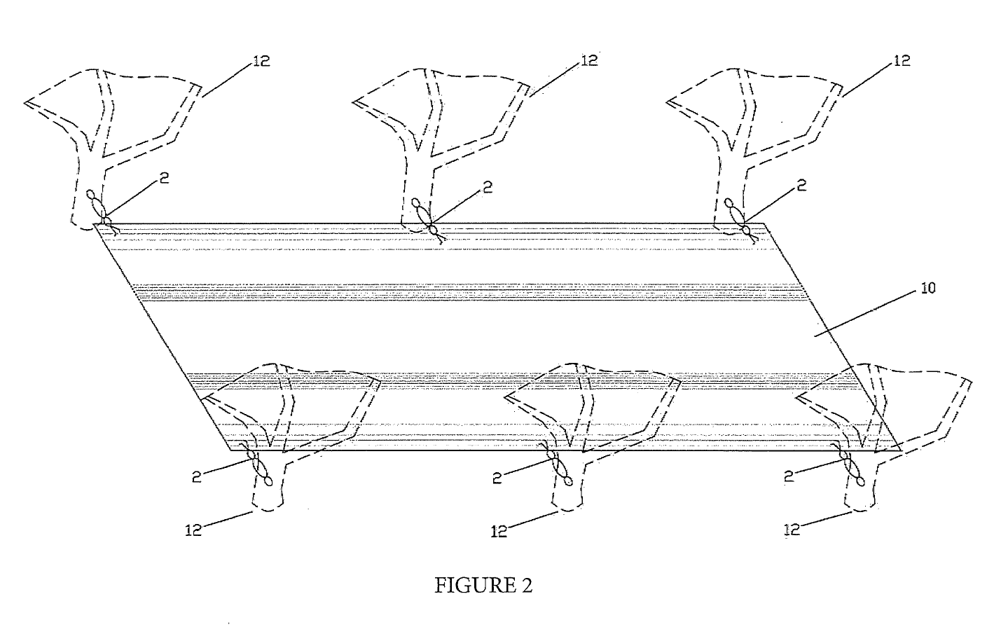

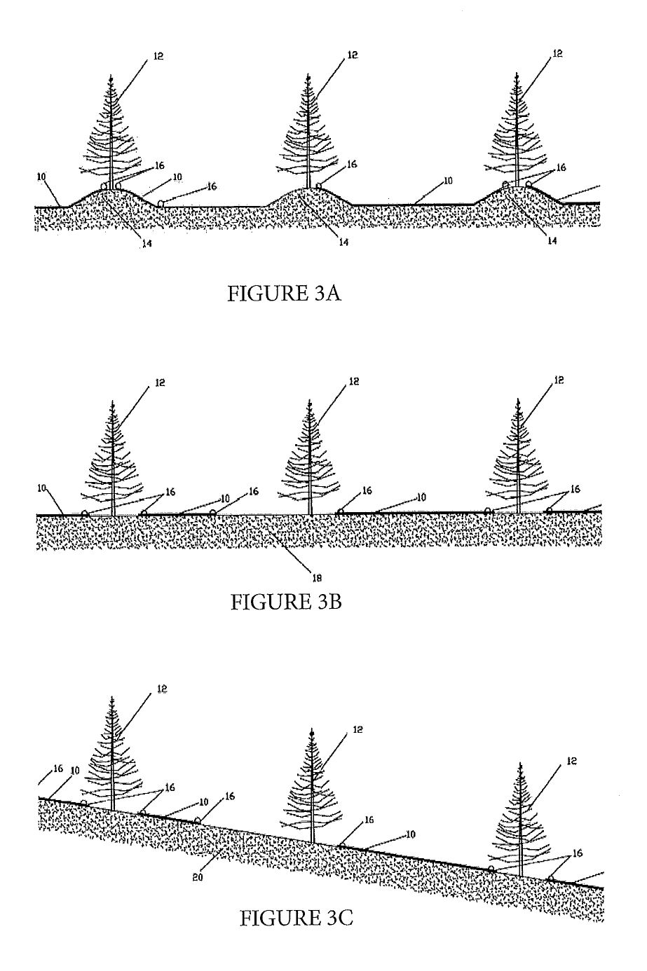

Typically the material has a greater length than width and is provided as a roll or in concertina folded form and referring to FIGS. 2-3c, lengths of the ground cover material 10 can be fixed between or beneath rows of crops, for example fruit trees 12, in various ways, depending on the primary function of the ground cover material, for example weed suppression and/or light reflectivity, and the surface profile of the ground soil underneath. Some of the various options and configurations will be described by way of example only.

FIG. 2 shows the ground cover material 10 positioned over the ground between and beneath rows of orchard trees 12. To anchor the material in place, optionally fastening claws 2 connect to the sheeting along its edges, and in turn may connect by loops or lengths of extensible or optionally inextensible material to staples hammered into the spaced trees as shown, or alternatively to stakes or pegs hammered into the ground, or to a wire extending along the row of the trees or vines, for example. The material may be anchored on or close to the ground, where the material is weed matting for example, or over but above the ground where the material is a reflective material provided to reflect solar radiation onto the fruit trees and fruit from below.

FIG. 3a shows lengths of ground cover material 10 laid on the ground underneath a tree (left) and between rows of orchard trees 12 (right). The orchard trees 12 in this form are grown on rows of mounded soil 14, and the lengths of material 10 are fixed peripherally along each side into the ground by stakes or pegs 16. FIG. 3b shows a similar fixing configuration for lengths of ground cover material laid on flat ground soil 18, and FIG. 3c shows use of the ground cover material on a sloped ground surface 20. It will be appreciated that the ground cover materials may be employed on any type of profile of ground surface, whether flat, mounded, sloped, undulating, contoured or a combination of these.

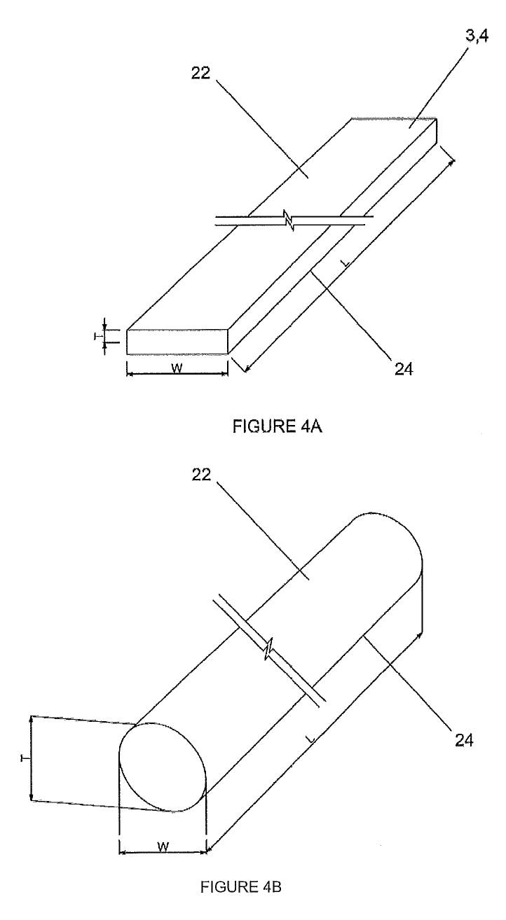

FIGS. 4A and 4B show dimensional profiles and/shapes of substantially rectangular and circular cross-section warp and/or weft tapes which may be used to weave the ground cover material, for the purpose of further explanation of the various embodiments of the ground cover material. The warp and/or weft tapes have an indefinite length, designated by reference double-ended arrow L. The top and bottom surfaces 22 and 24 of the tape form the top and bottom surfaces of the ground cover material once woven. In this form the tapes are substantially rectangular in cross-section and have a width, designated by double-ended arrow W, and a thickness, designated by double-ended arrow T. It will be appreciated that the width and thickness of the tapes are substantially uniform along the length of the tape. In other forms the tapes may have different cross-section shapes.

As illustrated in FIG. 1, a sheet material according to the present invention comprises a wicking material 5 woven into the sheet material. The wicking material is woven into the sheet material as a warp tape. That is, the sheet material comprises one or more warp tapes 5 comprising a wicking material. In the Illustrated embodiment the sheet material comprises a number of wicking material warp tapes spaced apart across the width of the sheet. As the wicking material is provided as a warp tape the wicking material runs longitudinally in the sheet material and preferably extends longitudinally for the full length of the sheet material.

In use, where the ground sheet material is placed on the ground, for example a sloping ground surface, rain water falling on the sheet material tends to run off the sheet material and not reach the ground surface below the sheet material, preventing water reaching plant root systems. However, in a sheet material according to the present invention, each wick provides a longitudinally extending line or area in the sheet material that allows water to flow or flow more freely through the sheet material than through the woven plastic material. A wick woven into the sheet material allows a higher flow of water through the sheet material at the wick than other areas of the sheet material woven from plastic warp and weft tapes. In use, the sheet material is positioned on the ground with the wick or wicks running across the slope of a sloping surface so that each wick provides a barrier that water running down the sloping surface on top of the ground cover will flow in to. Once water on the top surface of the sheet material contacts a wick, the water is drawn into the wick by capillary action. As the wick becomes saturated the water flows through the wick to the ground surface below the sheet material.

In preferred embodiments the plastic warps and the warps comprising wicking material are tightly woven together with the weft tapes so that the sheet material has minimal porosity and few if any apertures through the sheet material are apparent. The material is therefore effective as a weed suppressant and/or in a reflective application but additionally provides for a flow of water through the sheet material to reach the ground below the sheet material.

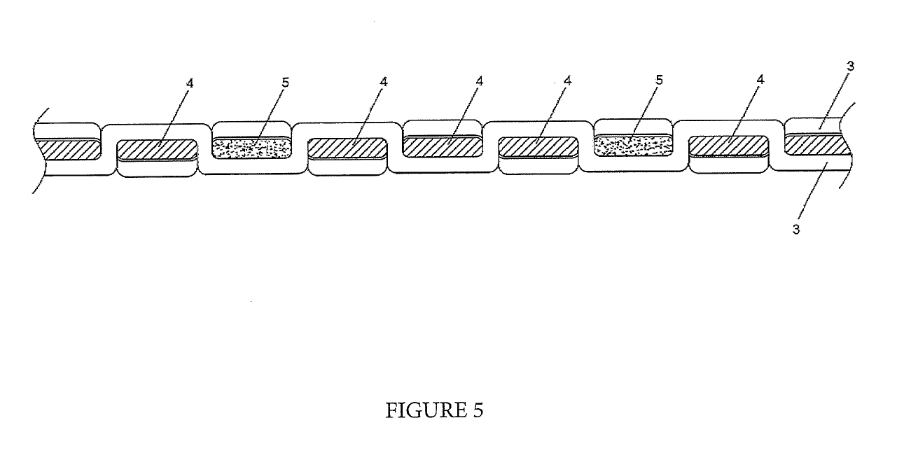

For illustrative purposes, in the illustrated embodiment of FIGS. 1 and 5, the warp tapes 5 comprising wicking material are spaced apart as every eighth warp tape in FIG. 1 and every fifth warp tape in FIG. 5. In practice, warp tapes 5 comprising wicking material may be spaced apart by 30 mm to 1 m, or 100 mm to 500 mm, or 100 mm to 300 mm. For example, where the plastic warp tapes have a width of 2 mm, the wicks may be woven in to the sheet material as every 50^{th} warp tape to provide a spacing of about 100 mm between longitudinally extending wicks. In some embodiments the warp tapes comprising wicking material are spaced apart every 125 mm.

In some embodiments the sheet material may comprise a plurality of warp tapes comprising wicking material grouped together. The grouped together wicks provide an area of high flow through the sheet material compared to the plastic woven warp and weft tape areas of the sheet material. In some embodiments the area is 2 mm to 200 mm wide, or 10 mm to 150 mm wide, or for example 125 mm wide. In some embodiments the sheet material may comprise spaced apart groups of wicks so that the sheet material has spaced apart high flow-through areas in the sheet material. For example, in some embodiments the areas are spaced apart by 30 mm to 1 m, or 50 mm to 500 mm, or 50 mm to 300 mm, or 50 mm to 150 mm.

In FIGS. 1 and 5 the wicking material warp tapes comprise a similar rectangular cross section to the plastic warp tapes. For example, the warp tapes comprising wicking material may be formed from a braided strap material with a similar cross section to the plastic tapes. In some embodiments the wicking material may be non-woven material such as a foam material or a felt material. Alternatively, in some embodiments the wicking material may be a woven material. In some embodiments the warp tapes may have a different cross section to the plastic tapes. For example a warp tape comprising a wicking material may have a similar thickness to the plastic warp tapes but may be wider or narrower than the width of the warp tapes. In some embodiments a warp tape comprising a wicking material may be thicker or thinner than the plastic warp tapes.

In some embodiments the wicking material comprises a yarn. In some embodiments the yarn is a single strand yarn comprising multiple fibres or filaments interlocked or bundled together to form the single strand. For example, in some embodiments the fibres or filaments are twisted together.

In some embodiments the yarn comprises multiple strands; each strand comprising fibres or filaments interlocked or bundled together, for example by twisting. In the multi-strand yarn the strands may be twisted together, for example in a Z-twist or an S-twist as known in the art of yarn manufacturing. For example in some embodiments the strands may be twisted together at about 40 to 300 twists per meter. Multi-strand yarns may be made with a cable twist, or a hawser twist, techniques well known in the art.

In some embodiments two or more yarns are arranged to run parallel to each other, abutting each other along their length, without being twisted together or entangled with each other. For example, a warp or weft tape may be substituted for two parallel yarns, each yarn being approximately half the width of the warp or weft tape it replaces. This may allow the yarns to fully occupy the space the warp/weft tape would otherwise occupy.

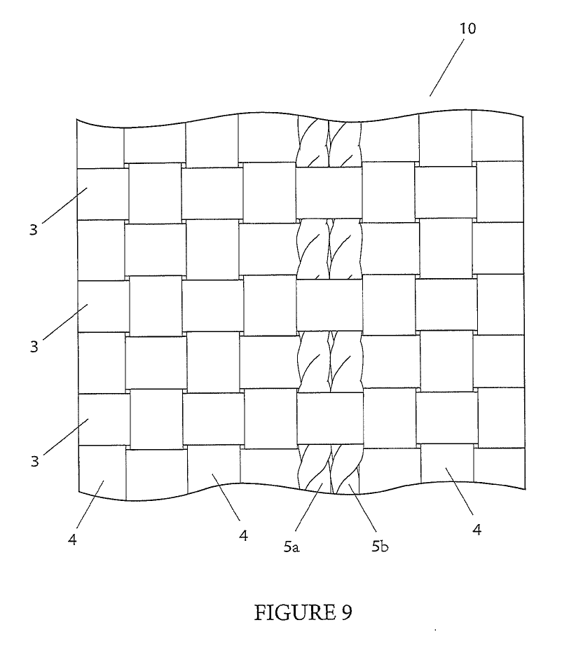

Such an embodiment is illustrated in FIG. 9. FIG. 9 illustrates a section of ground cover sheeting 10 woven from warp 4 and weft 3 tapes of a plastics material. The wicking material is comprised of two yarns 5a, 5b arranged parallel to each other, woven through the material in substitution for a regular warp tape. In FIG. 9, apertures can be seen between the warp and weft tapes, and between the two yarns of wicking material. Similar to the illustration of FIG. 1, these apertures are primarily for the purpose of Illustrating the weave, and in a preferred embodiment the warp and weft tapes are woven together tightly, and the yarns are pushed together, such that the apertures are not apparent.

To be suitable as a wicking material in a sheet material according to the present invention, preferably the yarn has many filaments or fibres, to provide a wicking effect where water may be drawn into the yarn by capillary action as a result of the surface tension of the water being broken by the small filaments or fibres. For example, a yarn suitable as a wicking material for the present invention preferably comprises at least 50 fibres or filaments per (lateral) cross section of the yarn. In a preferred embodiment the yarn comprises at least 150 fibres or filaments per cross section. Preferably the yarn comprises between 150 and 1800 fibres or filaments per cross section. In some embodiments the yarn may have a mass of about 2000 to 5500 denier or about 1000 to 2000 denier, or about 500 to 1000 denier. For example, in a multi-strand yarn, each strand may have a mass of about 500 to 3000 denier.

To Improve the wicking effect of the yarn in some embodiments the fibres or filaments are air twisted together. Air twisting ‘bulks out’ the cross sectional area of the yarn to include more air spaces between the fibres or filaments which may improve the wicking nature of the yarn. In some embodiments the fibres or filaments are twisted together, optionally by mechanical means, which may result in a stronger yarn but may be less preferred as a wicking material. Twisting filaments or fibres together adds strength to the total of the individual filaments or fibres, but it also compresses the filaments which may reduce water wicking/transmission. Air twisting may overcome some of the loss of water wicking/transmission as a result of the twisting by making the individual filaments more bulky when they are twisted. In a multi strand yarn, in some embodiments the strands are air twisted together to form the multi strand yarn. Alternatively, in a multi strand yarn, in some embodiments the air twisted strands are twisted together (optionally cable twisted together) to form the multi strand yarn.

In some embodiments, the fibres or filaments to be formed into a yarn are textured in a texturing process. For example, filaments are textured or bulked by overfeeding in steam or hot air into a stuffer box to induce a 3-dimensional crimp. Texturing and air-twisting of filaments to form yarns is a well known process in the manufacture of yarns for use in carpets or textiles.

In some embodiments the thickness of the wicking material varies along its length. Having some parts of the length of a yarn thicker than other parts may create points or regions of increased water transmission at certain points or parts of the length of the yarn. This may be desirable in some horticultural applications. Techniques to vary the thickness of a yarn along its length are well known in the art.

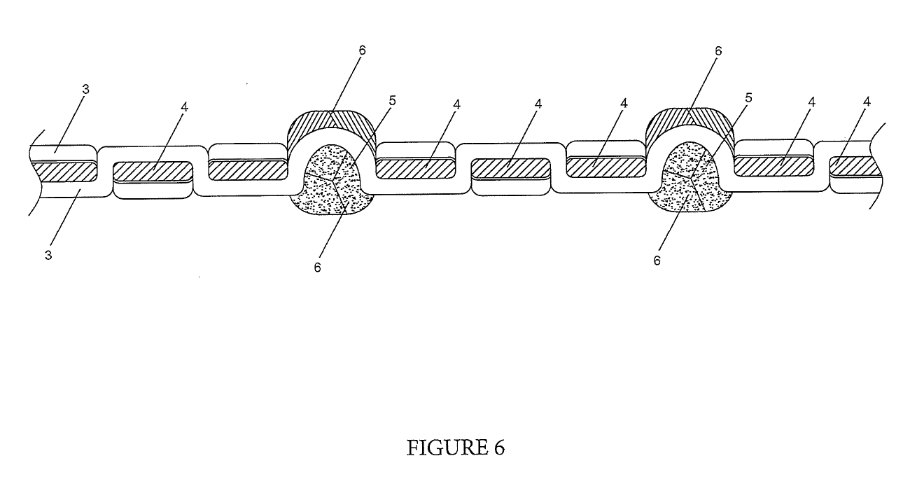

FIG. 6 is a cross section of a sheet material according to the present invention comprising a warp tape 5 comprising a yarn as the wicking material. In a preferred embodiment the weave of the warp tapes 4 and 5 and the weft tape 3 is tight so that the yarn is compressed by a weft tape on one side but may bulge out of the surface of the sheet material on an opposite side, as illustrated by the yarn 5 in FIG. 6. As the yarn bulges 6 above or below a weft tape the yarn provides greater surface area for water to collect and pass into the yarn to pass through the sheet material.

In some embodiments the yarn comprises fibres or filaments formed from polypropylene. Polypropylene is relatively inexpensive and durable. However polypropylene is more hydrophobic when compared to other materials. In some embodiments the yarn comprises fibres or filaments formed from polyethylene. In some embodiments the yarn comprises fibres or filaments formed from nylon. In some embodiments the yarn comprises fibres or filaments formed from polyester, for example polyethylene terephthalate (PET). Polyester may be a more expensive than other materials, however may be preferred as a wicking material as polyester is more hydrophilic than other materials such as polyethylene. The amount of the polyester material could be less than the polypropylene to allow the right economic balance between the two materials while providing acceptable levels of moisture transfer.

In some embodiments the yarn comprises a combination of fibres or filaments of differing materials, such as a combination of two or more polymers selected from the group consisting of polypropylene, polyethylene, nylon, polyester, polyurethane, polyvinyl compounds, polytetrafluorethylene, polycarbonate or polystyrene. In some embodiments the yarn comprises a combination of different types of the same polymer, for example the yarn may combine two types of polyester which have different rates of degradation, or two types of polyethylene which have different hydrophoblcity/hydropilicity; optionally in combination with other polymer materials. In some embodiments the yarn comprises fibres or filaments of a hydrophobic material and fibres or filaments of a hydrophilic material. In some embodiments the yarn comprises a combination of polyester filaments with polypropylene and/or polyethylene filaments. The yarn may comprise a single strand comprising polypropylene fibres or filaments bundled or interlocked together with polyester fibres or filaments. The hydrophobic nature of polypropylene or polyethylene may allow water to pass steadily through the yarn combination once it is drawn in by the polyester. The combination of the two yarns may provide a result more superior that a yarn made from any one of polypropylene, polyethylene or polyester on its own. Further, polyester may deteriorate over time creating void spaces within the wicking material structure, which may or may not fill with environmental contaminants, such as dust or dirt. Either way, the wicking material may still be effective as a wicking material, or may be even more effective after deterioration of the polyester. The polyester component of a yarn could be made up of two types, one that breaks down more rapidly than the other. The one that breaks down more rapidly may creates cavity or void spaces while the other longer lasting polyester type holds wicking activity for a longer time period.

In some embodiments the yarn comprises a first strand comprising fibres or filaments of a first material and a second strand comprising fibres or filaments of a second material. For example, the yarn may comprise a strand of polypropylene fibres or filaments (a polypropylene strand) and a strand of polyester fibres or filaments (a polyester strand). In some embodiments there may be more than one ‘first’ strand and/or more than one ‘second’ strand. For example, in some embodiments the yarn may comprise two polypropylene strands and a single polyester strand. In such an embodiment the polyester strand may act as a catalyst for water transfer, being more hydrophilic to improve the wicking nature of the yarn. The polypropylene strands may have a mass of about 1800 denier and the polyester strand may have a mass of about 600 denier.

The invention may comprise strands formed by twisting, air twisting, or air entangling formed into a yarn together with another or other strands formed by twisting, air twisting, or air entangling. The forming into a yarn may be by twisting (optionally cable twisting), air twisting or air entangling. When the yarn comprises three or more strands, two or more strands may be combined by twisting (optionally cable twisting), air twisting or air entangling, and those two or more strands may then be formed into a yarn with a third or more strands by twisting (optionally cable twisting), air twisting or air entangling. The combination of different techniques for forming a yarn enables the ability to balance water transmission of a yarn with strength characteristics.

In some embodiments the yarn may comprise a first strand comprising fibres or filaments air twisted together and at least one strand comprising fibres or filaments twisted together (I.e. twisted together without use of air injection). The at least two strands may be cable twisted together. The air twisted strands may provide an improved wicking characteristic while the twisting improves strength of the yarn. In some embodiments the yarn comprises at least two air twisted strands and a single twisted strand. In some embodiments the yarn comprises two air entangled strands and a single twisted strand. For example, two strands may be air twisted, or air entangled, together and then cable twisted together with a single strand.

In some embodiments the yarn comprises three air entangled yarns strands. Two strands may be air entangled with each other before air entangling with a third. Alternatively, all three strands may be air entangled together at the same time.

In some embodiments two strands may be twisted together, optionally cable twisted together, to form a yarn and then that yarn may be air twisted together with another strand. For example, a first strand and a second strand may be cable twisted together to form a yarn and then that yarn is air twisted with another first strand or second strand, wherein the first strand comprises polypropylene filaments and the second strand comprises polyester filaments.

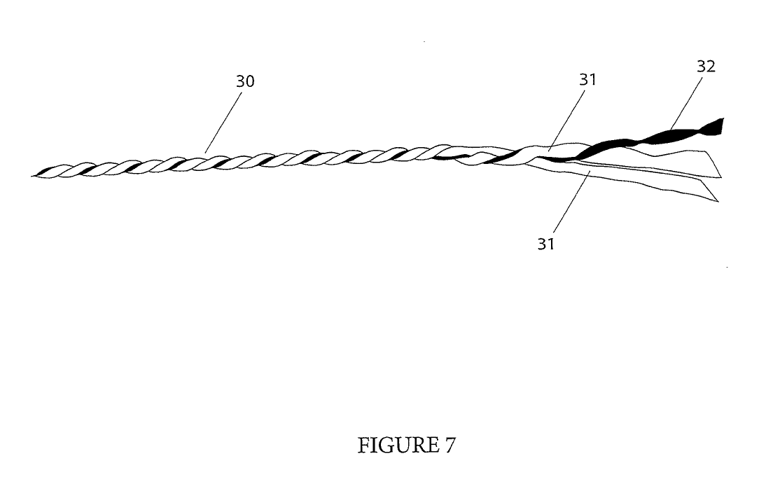

In some embodiments, a sheet material comprises a warp tape that is a yarn comprising two 1800 denier strands of polypropylene filaments and a single 600 denier strand of polyester filaments, the three strands air-twisted together. An example yarn 30 is illustrated in FIG. 7 comprising two air twisted strands of polypropylene filaments 31 and a single strand of air entangled polyester filaments 32, the three strands are twisted together. The warp and weft tapes of the sheet material are woven together in a tight weave for weed control. In an experiment, the sheet material was placed on a 20 degree slope with the length of the sheet running across the slope. Water was poured on the ground sheet above the yarn (the wick). The water ran down the ground sheet material and when reaching the wick was drawn into the wick. The amount of water transferring through the sheet material via the wick was collected on a weigh scale and showed a transfer rate of around 20% by weight through the sheet material. By comparison a cable-twisted yarn comprising two 1800 denier polypropylene strands transferred about 5% of the water poured on the sheet material. The same sheet material but without a wick did not allow any water to flow through the sheet.

In some embodiments a sheet material comprises a warp tape that is a yarn that comprises a strand comprising fibres or filaments of a first material, a strand comprising fibres or filaments of a second material, and a strand comprising fibres or filaments of a third material. For example the yarn may comprise one or more strands of polypropylene filaments, one or more strands of polyester filaments, and one or more strands of polyethylene filaments. In some embodiments the yarn may comprise a plurality of strands comprising fibres or filaments of the first material, a single strand comprising fibres or filaments of the second material, and a single strand comprising fibres or filaments of a third material. The combination of at least three strands of differing material filaments or fibres may impart a combination of useful features to the wicking material, including but not limited to improved wicking characteristics combined with improved strength material and a reduced cost material.

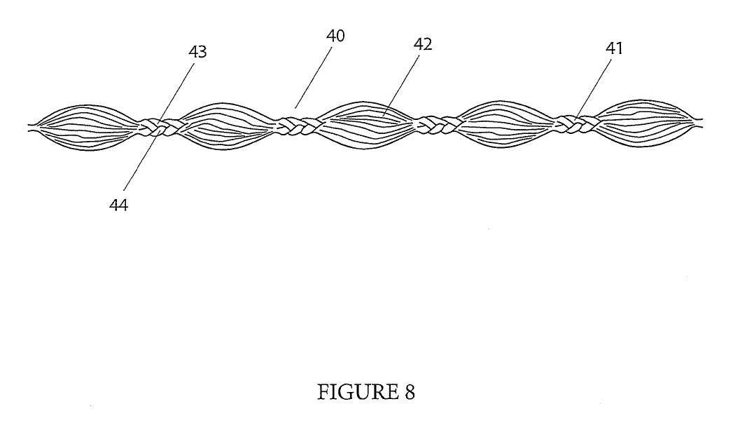

In some embodiments the wicking material comprises an air entangled yarn. Air entangled yarns are well known yarns for use in carpets or textiles. Air entangling of yarns may be described as tangling, entangling, intermingling or interlacing. To manufacture an air entangled yarn a continuous strand or strands are run under a predetermined tension through an air jet. The strand filaments of a yarn can be air entangled or interlaced together if a perpendicular or near perpendicular high pressure air jet is applied to the yarn. The air jet applied to the yarn creates a turbulence, splitting the yarn bundle and then forcing the individual filaments of one or more strands together, which can create a braiding effect on the filaments. Such a yarn may also be called a Draw Texturised Yarn (DTY). An air entangled yarn is characterised by having portions of entangled filaments spaced apart along the yarn at regular intervals. An example air entangled yarn 40 is illustrated by the schematic representation of FIG. 8, comprising air entangled portions 41 spaced apart along the length of the yarn. An air entangled yarn may provide improved wicking characteristics as the portions 42 of fibres or filaments not entangled have more bulk having increased air space between the fibres or filaments compared to twisted strands or fibres. The entangled portions of the filaments hold the filaments together in the yarn without a requirement for twisting.

In some embodiments one or more strands, formed by air entanglement, air twisting or twisting, may be combined with a further or other strands formed by air entanglement, air twisting or twisting. The strands may be combined by twisting together, optionally cable twisting together. For example, one or more air entangled strands may be formed by the air entanglement process, or one or more air twisted strands may be formed by the air twisting process, and then these strands may be combined by twisting, optionally cable twisting, with another or other strands formed by the air entanglement or air twisting process. This may allow, for example, a combination of water transmission advantages of an air entangled yarn with higher strength advantages of a cable twisted yarn. Alternatively, the strands may be made by the same process, be it air entanglement, air twisting, or twisting, and then combined together by twisting (optionally cable twisting). Alternatively the entire yarn could be comprised of filaments made by any one of the air twisting, air entanglement or cable twisting methods (i.e. not combined with any other strands).

In some embodiments the wicking material comprises a first strand 43 comprising fibres or filaments of a first material and a second strand 44 comprising fibres or filaments of a second material, the fibres or filaments of the first and second strands air entangled together. For example, in some embodiments the wicking material yarn comprises a 1800 denier strand of polypropylene filaments and a 600 denier strand of polyester filaments, the polypropylene filaments and the polyester filaments air entangled together. In some embodiments the wicking material yarn comprises a 1800 denier strand of polypropylene filaments and a 1200 denier strand of polyester filaments, the polypropylene filaments and the polyester filaments air entangled together.

In the illustrative embodiments described the wicking material is included in the sheet material as warp tapes and so run longitudinally in the sheet material. This is useful for water flow through the sheet material where the sheet material is positioned across a sloping surface. In some conditions, a sheet material may be positioned along a sloping surface, in which case the sheet material may comprise one or more weft tapes comprising a wicking material to form a wick running across the sheet material. In some embodiments the sheet material may comprise lateral wicks as weft tapes spaced apart along the length of the sheet material, or may comprise a group or groups of weft tapes comprising wicking material. Spacing of wicking material weft tapes may be similar to the spacing of wicking material warp tapes provided by example above. In some embodiments, the sheet material may comprise both warp tapes comprising wicking material and weft tapes comprising wicking material so that regardless of the direct of slope of a ground surface on which the sheet material is placed, water running over the sheet material down a slope will run into one or more wicks to penetrate the sheet material. In some applications where the sheet material is provided aboveground or on flat ground, water may tend to pool in areas across the sheet. In such applications having wicking material as both warp and weft tapes may be preferred.

In some embodiments, the spacing between warp tapes comprising wicking material, or the spacing between groups of warp tapes comprising wicking material, varies across the width of the material, so that some lengthwise extending regions of the material have a higher density of warp tapes comprising wicking material and other lengthwise extending regions have a lower density of warp tapes comprising wicking material. In some embodiments the thickness of the wicking material, and/or the ability of the wicking material to transmit water or water vapour (i.e. the ease that water or water vapour may flow through the wicking material), differs instead of, or in addition to, the spacing of the warp tapes comprising wicking material.

In some embodiments the spacing between weft tapes comprising wicking material, or the spacing between groups of weft tapes comprising wicking material varies across the length of the material, so that some widthwise extending regions of the material have a higher density of weft tapes comprising wicking material and other widthwise extending regions have a lower density of weft tapes comprising wicking material. In some embodiments the thickness of the wicking material, and/or the ability of the wicking material to transmit water or water vapour (i.e. the ease that water or water vapour may flow through the wicking material), differs instead of, or in addition to, the spacing of the weft tapes comprising wicking material.

Various embodiments have been described for allowing water to transfer from above the ground sheet material to below the ground sheet material. In some embodiments of the present invention a ground sheet material comprising a warp or weft tape comprising a wicking material may also allow excess moisture below the ground sheet material to transfer to above the ground sheet material. The wicking material may allow water vapour to transfer through the ground sheet material. For example, with ground sheet materials placed between rows of trees the soil beneath the sheet material may be prone to having excessive moisture due to be being covered, as the sheet material may prevent moisture evaporating from the ground. This effect may be more pronounced in the case of reflective ground sheet materials that reflect solar radiation preventing the ground from warming to aid with evaporation of moisture. The presence of the wicking material to a ground sheet material as described may aid in the drawing of moisture from the soil surface to the air above the sheet material, the wick being the means to allow the movement for moisture to the air above. For example the wicking material may soak water from the ground to then evaporate from the wicking material from the upper surface of the wicking material. The wicking material may allow transfer of water vapour from below the ground sheet material to the atmosphere above the ground sheet material. With reference to FIG. 6, wicking material 5 may collect moisture from the ground surface below the sheet material to allow the moisture from below the ground sheet material to evaporate from the upper surface of the ground sheet material.

The wicking material may also provide a barrier for water moving on the underside of the ground sheet material so that water movement is restricted from flowing on the underside of the material. For example, condensation may form on the underside of the ground sheet material which may run across the underside of the ground sheet material. The condensation or water on the underside of the ground sheet material may only run as far as a line or area of wicking material. The water or condensation may be transferred through the sheet material to the upper surface of the sheet material via the wicking material, and the moisture may be evaporated away from the upper surface of the sheet material from the wicking material.

### Example

To demonstrate the effectiveness of the invention a laboratory test was conducted on a group of samples of woven materials, each material being the same except for the wicking material. The main body of the material was formed of woven tapes, woven in a crammed weave pattern. The tapes were cut from a film that had been extruded from a polypropylene resin. The tapes had a width of 2.6 mm, mass of 940 denier, thickness of about 0.05 mm, and an insertion rate of 10.2 tapes per inch in the warp direction×10.5 tapes per inch in the weft direction. The porosity (as defined herein) of the main body of the material was approximately zero, and it had a weight of 85 gsm.

A wicking material, in the form of a yarn, was woven through the main body of the material in substitution for a regular warp tape, every 50 tapes (i.e. approx every 12.5 cms). The characteristics of the wicking yarn from each sample are set out in Table 1 below.

TABLE 1

| Name of Wicking | |
|---|---|
| Material | Description of Material |
| PP cable twisted, | A 3 ply yarn formed from polypropylene |
| one 3600D yarn | filament, 3600 denier and 148 filaments per ply |
| PP cable twisted | Two 3 ply yarns formed from polypropylene |
| two parallel | filament, 3600 denier and 148 filaments per |
| 3600D yarns | ply; the yarns running side-by-side without |
| | being twisted or entangled together, they |
| | occupy the space that a single warp tape would |
| | otherwise occupy |
| PP cable twisted, | A 2 ply cable twisted yarn formed from a |
| 4200D | polypropylene multifilament comprising of |
| | approximately 150 filaments and a |
| | polypropylene multifilament comprising of |
| | approximately 150 filaments, 4200 denier |
| PP/PET air | A 2 ply air entangled yarn formed from 2400D |
| entangled, | polypropylene multifilament's comprising 1200 |
| 3000D | filaments, and air entangled 600D polyester |
| | multifilament comprising 285 filaments, giving |
| | 3000 denier total. Total filaments is 1485 and |
| | there are 45 nips per metre |
| PP/PET air | A 3 ply air twisted yarn formed from two air |
| twisted, 4200D | twisted 1800 denier polypropylene |
| | multifilament's each comprising 500 filaments, |
| | which are combined by twisting with one 600 |
| | denier polyester multifilament comprising 700 |
| | filaments, giving 4200 denier and 1770 |
| | filaments in total. There are 110 twists per |
| | metre |
| PP/PET air | A 3 ply air twisted yarn formed from two air |
| twisted 4800D | twisted 1800 denier polypropylene |
| | multifilament's each comprising approximately |
| | 400 filaments, which are combined by twisting |
| | with 1 1200 denier polyester multifilament |
| | comprising approximately 900 filaments, giving |
| | 4800 denier total and 1770 filaments in total. |
| | There are 110 twists per metre. |

### Test Method

Each sample was formed by taking a cutting from the materials being tested using a 100 cm² circular cutter. The samples were cut so that each had a single length of wicking material passing from approximately opposing points on the circumference of the circle formed by the cutting (i.e. so that the wicking material approximately bisected the circular sample). A sample of woven material with no wicking yarn was also tested. Five replicates of the following test method were performed on each sample, for most samples. The results from the three most consistent replicates from each set of five replicates were averaged to produce a water transmission figure for each sample.
1. A piece of absorbent dry paper was weighed and placed on a planar support surface, inclined at 20° to horizontal
2. The sample being tested was laid flat on top of the paper, and edges pressed down so that the sample was flush against the paper to simulate the fabric being pressed flat against the soil. The yarn forming the wicking material was arranged such that it traversed horizontally across the inclined planar support surface
3. Using a pipette, 1.5 mL of water was dropped on the sample at a rate of approximately 1 drop per second. The droplets were dropped from a height of about 10 mm from a point approximately 2.5 cm above (in the plane of the material) the yarn forming the wicking material, and were spread out across a horizontal width parallel to the yarn of approximately 2.5 cm, oscillating back and forth across that width at a rate of approximately 5 drops per width.
4. When the 1.5 mL had been administered, a period of approximately 30 seconds was allowed for the last droplets to settle or pass over the yarn, the paper under the sample was then removed and weighed.
5. Water transmission was calculated as a percentage using equation ((wet paper(g) dry paper(g))/1.5 (g))*100
6. Each round of experiments was repeated using a solution containing water and a common household dishwashing detergent (10 drops per 1 litre of water). The dishwashing detergent was to emulate environmental contaminants (e.g. dust or dirt) that would be present in the field.

Results from the testing are illustrated in Table 2 below.

TABLE 2
20° Incline

| | Poly- | | | | Denier |
|---|---|---|---|---|---|
| | propylene | Polyester | Total | | divided |
| | in Wick- | in Wick- | Denier of | Water | by Water |
| Wicking | ing | ing | Wicking | Trans- | Trans- |
| Material | Material | Material | Material | mission | mission |
| Fabric Only | n/a | n/a | n/a | 0% | — |
| (no wicking | | | | | |
| material) | | | | | |
| PP cable | 1 yarn, | — | 3600D | 19% | 190 |
| twisted, | 3600D | | | | |
| single, | | | | | |
| 3600D | | | | | |
| PP cable | 2 yarns, | — | 2 yarns, | 26% | 277 |
| twisted | 3600D each | | 3600D | | |
| two parallel | | | each | | |
| 3600D yarns | | | | | |
| PP cable | 1 yarn, | — | 4200D | 27% | 156 |
| twisted, | 4200D | | | | |
| 4200D | | | | | |
| PP/PET air | 1 strand, | 1 strand | 3000D | 33% | 90 |
| entangled, | 2400D | 6000D | | | |
| 3000D | | | | | |
| PP/PET air | 2 strands, | 1 strand, | 4200D | 35% | 120 |
| twisted, | 1800D each | 600D | | | |
| 4200D | | | | | |
| PP/PET air | 2 strands, | 1 strand, | 4800D | 43% | 112 |
| twisted | 1800D each | 1200D | | | |
| 4800D | | | | | |

### DISCUSSION

The sample without a wicking material, i.e. Fabric Only (no wicking material), was impermeable to water. For other samples, the material of the main body was the same as the material of the sample without wicking material; accordingly any water transmitted through the other samples was being transmitted though the wick section of the sample.

The polypropylene cable twisted yarns (without PET) both transmitted water, 19% and 26%, with the two yarn sample showing a small increase, 7%, in transmittance compared to the one yarn sample.

The 4200D air twisted polypropylene (without PET) sample showed, 27%, similar transmission to that of the polypropylene, 26%, (without PET) cable twisted yarn with two 3600D yarns.

The 4200D air twisted polypropylene plus PET sample showed significantly improved transmission compared to thicker 4200D air twisted polypropylene sample (without PET), showing that polyester improves water transmission.

The 4800D polypropylene plus PET air twisted sample, 43% showed improved transmission, 8%, over the 4200D polypropylene plus PET air twisted sample, 35% illustrating that a thicker wicking material may provide increased transmission compared to a thinner wicker material formed of the same makeup.

The 3000D air entangled polypropylene plus PET sample, 33% or 1% per 90 denier, showed similar transmission to the higher denier 4200D polypropylene plus PET air twisted sample, 35% or 1% per 120 denier, illustrating, when the lower denier of the air entangled sample is taken into consideration, that air entanglement combined with polyester may provide a surprisingly high transmittance of water, and be a very effective means to introduce water transmissibility to a woven ground cover sheet material.

In general, the cable twisted and air twisted polypropylene wicking materials both showed transmission of water. Superior transmission was shown by the air twisted wicking materials which included polyester and the air entangled wicking material, with transmission at 35% and 43% respectively for 4200D and 4800D air twisted materials including polyester, and 33% for the air entangled wicking material.

Thicker yarns (i.e. those of greater denier) gave greater transmission, as shown by a comparison of the 3000D and 4800D air twisted yarns including polyester. This is believed to be a result of water pooling above the horizontally aligned wicking material, and providing opportunity for more contact time between the water and the wicking material plus more wicking pull force. The water would also travel more slowly over the thicker materials, as they present a larger “bump” for the water to overcome as it travelled down the sample.

The air entangled wicking material showed surprisingly high transmission considering the denier of wicking material of this sample. The 33% transmission of the air entangled sample, at 3000D, is comparable to the 35% transmission of the air twisted sample which included polyester with a denier of 4200, despite the air entangled sample being of much lower denier. It is believed that such transmission from the air entangled yarn results from a higher proportion of air or void space in the air entangled filaments compared to cable twisted or air twisted filaments. Such air or void spaces may assist in the ability for water or water vapour to flow more freely through such wicking material.

The foregoing describes the invention including preferred forms thereof. Alterations and modifications as will be obvious to those skilled in the art are intended to be incorporated in the scope hereof as defined in the accompanying claims.

1. A ground cover sheet material having a greater length than width and woven from warp and weft elements of a plastics material and at least one warp element or weft element comprising a wicking material to form a longitudinal or lateral wick in the sheet material through which water or water vapour may flow or flow more freely than through the woven plastic warp and weft elements, wherein the longitudinal or lateral wick is thicker than the warp or weft elements of a plastics material such when the sheet material is positioned on sloped ground such that the top surface of the material forms a sloping surface with the longitudinal or lateral wick running across the sloping surface, the wick provides a barrier to water running down the sloping surface.

2. A ground cover sheet material according to claim 1 comprising a plurality of the warp elements or weft elements each comprising a wicking material to form a plurality of the wicks.

3. A ground cover material according to claim 2 wherein the wicks are spaced apart across the width of the sheet material or along the length of the sheet material.

4-5. (canceled)

6. A ground cover sheet material according to claim 1 wherein the wicks or groups of wicks are spaced apart evenly across the width of the sheet material.

7-10. (canceled)

11. A ground cover sheet material according to claim 1 wherein the wicking material comprises a yarn comprising fibres or filaments interlocked or bundled together.

12. A ground cover sheet material according to claim 11 wherein the fibres or filaments are twisted together, air twisted together, or air entangled together.

13. A ground cover sheet material according to claim 11 wherein the yarn is a single strand yarn comprising fibres or filaments interlocked or bundled together.

14. A ground cover sheet material according to claim 11 wherein the yarn comprises a plurality of strands, each strand comprising fibres or filaments interlocked or bundled together.

15-16. (canceled)

17. A ground cover sheet material according to claim 1 wherein the wicking material is comprised of one or more polymers selected from the group consisting of polypropylene, polyethylene, polyester, nylon or polyurethane, polyvinyl compounds, polytetrafluorethylene, polycarbonate or polystyrene.

18-24. (canceled)

25. A ground cover material according to claim 1 wherein the wicking material comprises a yarn, the yarn comprising at least one strand that has fibres or filaments that have been air entangled together.

26. A ground cover material according to claim 25 wherein the at least one strand that has fibres or filaments that have been air entangled together includes fibres or filaments of polyester in combination with fibres or filaments selected from the group consisting of polypropylene, polyethylene or nylon.

27. A ground cover material according to claim 13 wherein the fibres or filaments are air entangled, the yarn comprising portions of entangled filaments spaced apart along the yarn.

28. A ground cover material according to claim 14 wherein the strands are air entangled together, the fibres or filaments of the strands being air entangled together at portions of entangled filaments spaced apart along the yarn.

29-37. (canceled)

38. A ground cover sheet material according to claim 14 wherein one or more of the strands comprises fibres or filaments of a first material and fibres or filaments of a second material.

39. (canceled)

40. A ground cover sheet material according to claim 14 wherein the yarn comprises a strand comprising fibres or filaments of a first material and a strand comprising fibres or filaments of a second material.

41-45. (canceled)

46. A ground cover sheet material according to claim 40 wherein the yarn comprises two air entangled strands, each comprising fibres or filaments of a first material, and an air entangled strand comprising fibres or filaments of the second material.

47. A ground cover sheet material according to claim 46 wherein the first material is a bulking material and the second material is a hydrophilic material.

48. A ground cover sheet material according to claim 46 wherein the first material is polypropylene and the second material is polyester.

49-70. (canceled)

71. A method for enhancing the growth or development of a crop plant and/or of reducing weed growth comprising laying and maintaining on the ground a ground cover material according to claim 1.
